(19) United States
(12) Patent Application Publication
(10) Pub. No.: US 2021/0008843 A1
(43) Pub. Date: Jan. 14, 2021

(54) METHOD FOR PRODUCING A COMPOSITE PANE WITH A FUNCTIONAL ELEMENT HAVING ELECTRICALLY CONTROLLABLE OPTICAL PROPERTIES

(71) Applicant: SAINT-GOBAIN GLASS FRANCE, COURBEVOIE (FR)

(72) Inventors: Marcel KLEIN, BAESWEILER (DE); Sebastian SCHURSE, ÜBACH-PALENBERG (DE)

(21) Appl. No.: 16/980,171

(22) PCT Filed: Jun. 24, 2019
(86) PCT No.: PCT/EP2019/066629

§ 371 Date: Sep. 11, 2020

(30) Foreign Application Priority Data
Jul. 24, 2018 (EP) 18185178.3

(51) Int. Cl. B32B 17/10

(52) U.S. Cl. CPC B32B 17/10036; B32B 17/10293; B32B 2605/006; B32B 2369/00; B32B 2307/202; B32B 17/10504

(57) ABSTRACT

A method for producing a composite pane with a functional element having electrically controllable optical properties, includes providing a first pre-composite including a first thermoplastic laminating film and a first barrier film as well as a second pre-composite including a second thermoplastic laminating film and a second barrier layer trimming and the pre-composites substantially to the dimensions of the composite pane, forming a circumferential back cut in the barrier films, arranging the first pane, the first pre-composite, a functional element, the second pre-composite, and a second pane one over another in this order, the barrier films being arranged sheet-wise directly adjacent the functional element, surrounding the circumferential edge of the functional element, and touching one another sheet-wise at least in sections in an overhang u protruding beyond the functional element, and bonding the layer stack.

The invention relates to a method for producing a composite pane with a functional element having electrically controllable optical properties and in particular a vehicle pane with a functional element.

In the vehicle sector and in the construction sector, composite panes with electrically controllable functional elements are often used as sun screens or as privacy screens.

Thus, for example, windshields are known in which a sun visor is integrated in the form of a functional element having electrically controllable optical properties. In particular, the transmittance or the scattering behavior of electromagnetic radiation in the visible range is electrically controllable. The functional elements are usually film-like and are laminated into or glued onto a composite pane. In the case of windshields, the driver can control the transmittance behavior of the pane itself relative to sunlight. Thus, a conventional mechanical sun visor can be dispensed with. As a result, the weight of the vehicle can be reduced and space gained in the roof region. In addition, the electrical control of the sun visor is more convenient than the manual folding down of the mechanical sun visor.

Windshields with such electrically controllable sun visors are, for example, known from WO 2014/086555 A1, DE 102013001334 A1, DE 102005049081 B3, DE 102005007427 A1, and DE 102007027296 A1. Functional elements are, moreover, also used as roof panels for shading vehicle glazings, as described, for example, in EP 2010385 B1.

Typical electrically controllable functional elements contain electrochromic layer structures or single particle device (SPD) films. Further possible functional elements for realizing an electrically controllable sun screen are so-called PDLC functional elements (polymer dispersed liquid crystal). Their active layer contains liquid crystals that are embedded in a polymer matrix. When no voltage is applied, the liquid crystals are oriented in a disorderly fashion, resulting in strong scattering of the light passing through the active layer. When a voltage is applied on the surface electrodes, the liquid crystals align themselves in a common direction and the transmittance of light through the active layer is increased. The PDLC functional element acts less by reducing total transmittance, but, instead, by increasing scattering to ensure protection against glare.

Laminated-in functional elements and in particular PDLC functional elements often have, in the edge region, undesirable aging phenomena, such as brightening and changes in the shading. The diffusion of compounds, in particular of plasticizers, out of the thermoplastic laminating films of the composite pane into the active layer of the functional element is considered to be the cause. Sealing the edge region of the functional element prevents the diffusion and provides a remedy, for example, according to US 20110171443 A1, by applying an adhesive strip that closes the open edge of the active layer. However, such an adhesive strip must be manually placed around the open film edge, making automation difficult.

DE 20 2018 102 520 U1 describes a composite pane with a functional element having electrically controllable optical properties that is contacted via strip-shaped bus bars.

WO 2014/086555 discloses a composite pane including a functional element, wherein a thermoplastic film including a luminescent material is introduced between the outer pane of the composite pane and the functional element.

WO 2017/157626 describes a windshield with a functional element as an electrically controllable sun visor, wherein regions of the thermoplastic intermediate layer that connect the functional element to the outer pane are colored or tinted.

WO 2010/032068 describes the problems of edge sealing an SPD functional element against plasticizers defusing in from the thermoplastic intermediate layer of the composite pane.

US 2005/0227061 A1 also describes the edge sealing of SPD functional elements in composite panes, wherein strip-shaped PET films are applied on the edges of the functional element.

The object of the present invention is, consequently, to develop an improved method for producing a composite pane, which provides a composite pane having a highly aging-resistant functional element and enables simplified handling as well as a high degree of automation. Also provided should be a composite pane having a functional element with improved aging resistance as well as use thereof.

The object of the present invention is accomplished by a method according to the independent claim 1. Preferred embodiments are apparent from the dependent claims.

The invention relates to a method for producing a composite pane with a functional element having electrically controllable optical properties. Herein, barrier films that seal the open edge of the functional element and thus prevent aging are used in the vicinity of the functional element. According to the invention, these barrier films are used in the form of a pre-composite comprising the barrier film and a thermoplastic film. In a first step of the method (step a), a first pre-composite comprising a first thermoplastic laminating film and a first barrier film as well as a second pre-composite comprising a second thermoplastic laminating film and a second barrier layer are provided. The term “bilayer” is also common for such a sheet-wise film pre-composite comprising thermoplastic laminating film and barrier film. The pre-composites are trimmed substantially to the dimensions of the composite pane to be produced. Thereafter or simultaneously, a circumferential back cut of the barrier films (step b) is done. The barrier film is selectively removed in the edge region of the pre-composite. The circumferential edge of a barrier film is thus set back relative to the circumferential edge of the thermoplastic laminating film of the same pre-composite in the direction of the central area of the pre-composite. Therefore, only the first thermoplastic laminating film or the second thermoplastic laminating film remains in the edge region of the first or second pre-composite. The pre-composites thus prepared are then combined with at least one functional element and at least two panes in a layer stack (step c) and laminated sheet-wise (step d). At this time, additional elements, such as additional film components, can also be used. For lamination of the assembly, a layer stack is first formed from at least a first pane, the first pre-composite, a functional element, the second pre-composite, and a second pane, which are arranged one above another in this order (step c). Care must be taken that the barrier films are arranged sheet-wise directly adjacent the functional element and surround the circumferential edge of the functional element. To that end, the barrier films are trimmed in step b such that there is an overhang beyond the circumferential edge of the functional element. This is, at least in sections, a common overhang of the barrier films, in which the first and the second barrier film touch each other sheet-wise. Thus, the edge of the functional element is closed by means of the barrier films such that no plasticizer from the thermoplastic laminating films can enter the active layer of the functional element. The overhang of the first and the second barrier film beyond the edge of the functional element can be identical or different. A small offset of the two overhangs relative to one another can also result from a less than completely congruent placement of the bilayers on one another. However, even in such a case, there is, at least in sections, a common overhang, which ensures reliable sealing. Finally, the layer stack comprising, arranged in this order, at least a first pane, a first thermoplastic laminating film, a first barrier film, a functional element, a second barrier film, a second thermoplastic laminating film, and a second pane is bonded by autoclaving to form a composite pane (step d).

The method according to the invention makes available a composite pane with a functional element with high aging resistance, ensuring, at the same time, simple handling through the use of pre-composites (bilayers) comprising thermoplastic laminating film and barrier film. Due to the fact that these films are used as bilayers, the barrier film retains its intrinsic stability even after the back cutting of the barrier film in the edge region of the bilayer. In particular, with small functional elements, the exact positioning of a barrier film adapted in its size to the functional element is difficult since it must be applied precisely and slippage in the layer stack must absolutely be prevented. With methods known in the prior art, this is possible only to a limited extent. In addition, when using a single barrier film, electrostatic effects occur, making handling even more difficult. By means of the use according to the invention of bilayers, the barrier films can be made in any shape. This enables even a rounded or round edge design of the functional element. Taping the open edges of the functional element, as known in the prior art, is not possible with rounded geometries since wrinkling of the adhesive tape occurs. By means of the method according to the invention, air bubble inclusions and resultant optical defects or adverse effects are avoided since the barrier films rest uniformly and wrinkle-free on the functional element.

The pre-composites according to the invention have no adhesion promoters, adhesion improving coatings, and/or adhesives at all. This is true for all the film surfaces of the pre-composites. There is no adhesion promoter between the barrier films and the associated thermoplastic laminating film, nor between the sheet-wise touching sections of the barrier films, or between the barrier film and the functional element. This absence of an adhesion promoter is a distinguishing feature relative to the prior art structures, in which fixation is essential to prevent slippage of the barrier film during assembly of the layer stack. The prior art also includes the teaching that in order to produce a sufficient diffusion barrier for plasticizer, gluing of the elements to be sealed is necessary. The inventors have discovered that this is, astonishingly, not necessary; and by means of the method according to the invention, an excellent diffusion barrier for plasticizer can be obtained even without gluing. Diffusion of plasticizers and other chemical compounds out of the thermoplastic laminating films into the active layer of the functional element can thus be effectively prevented and clouding of the edge region of the functional element can be prevented. Using bilayers per the method according to the invention further yields low susceptibility to defects during the production process, enabling a high degree of automation. Thus, the method according to the invention makes a composite pane with a functional element having improved aging resistance available with significantly reduced production costs.

In an advantageous embodiment of the method according to the invention, the back cut of the barrier films in step b is done such that the common overhang u is present on all sides, in other words, on all of the four or more side edges of the functional element. The first barrier film is arranged in the form of the first pre-composite on the underside of the functional element, and the second barrier film is arranged in the form of the second pre-composite on the top of the functional element. In the region of the overhang, an overhanging region of the first barrier film directly touches an overhanging region of the second barrier film. In the case of a film-like functional element, “underside” and “top” mean the two large surfaces that are arranged parallel to the outer pane and the inner pane, in other words, the outer surfaces and the inner surfaces of the functional element. “Side edges” describe the surfaces of the functional element, which are very thin in film-like functional elements. The barrier films can cover the top and/or the underside of the functional element completely or only in sections.

The first and the second pre-composite are created before step a). Preferably, the first barrier film is joined to the first thermoplastic laminating film by heating to form a first pre-composite; and the second barrier film is joined to the second thermoplastic laminating film by heating to form a second pre-composite. Preferably, the barrier film and the thermoplastic film, which are to be shaped into a pre-composite, are heated and pressed together. This exertion of pressure in the heated state creates a stable pre-composite, which does not separate even upon cooling of the films. The steps of heating and pressing the films can be carried out in succession, for example, by passing the barrier film and the thermoplastic film together through a heater battery and subsequently pressing them together by a pair of rollers. In a particularly preferred embodiment, a heated pair of rollers that presses the barrier film and the thermoplastic laminating film together and joins them, in one step, to form a pre-composite is used. Using a pair of rollers for joining the films is particularly advantageous since air inclusions between the film components are reliably removed. The pre-composite created comprising in each case one barrier film and one thermoplastic laminating film can be wound onto a roll and thus optionally produced and stocked in advance.

It has proved advantageous to heat the barrier film and/or the thermoplastic laminating film to a temperature of 35° C. to 75° C., preferably of 35° C. to 60° C., particularly preferably of 40° C. to 50° C., and to press them together sheet-wise under pressure to form a pre-composite. Within these temperature ranges, the films adhere well to each other. The barrier film and the thermoplastic laminating film can both be heated to different temperatures. Preferably, they are heated to the same temperature. In a particularly advantageous embodiment, the barrier film and the thermoplastic laminating film are in each case unwound from a roll, routed through a pair of rollers at a temperature of 45° C., and pressed together sheet-wise and wound onto a role as a pre-composite. The statements generally referring to one pre-composite are valid for the first and the second pre-composite.

In a preferred embodiment, cutouts are made in the barrier films of the pre-composites. The cutouts are placed such that the barrier films cover the edges of the functional element and have an overlap with the functional element. Accordingly, the barrier films are removed in the region of the functional element itself, outside the edge region of the functional element. The barrier films are not needed in these regions. Therefore, the barrier films are preferably present only in the edge region of the functional element, where sealing of the open edges of the functional element is necessary. This is advantageous since there is improved adhesion in the region of the cutouts of the barrier films. The barrier film and the adjacent carrier film of the functional element can, for example, be made of PET. However, two PET films do not adhere to one another even after bonding of the pane by autoclaving. This results in worsened optical quality in this region. Since commercially available PET films usually have a smooth unstructured surface, air inclusions between two such films are also favored, which also have negative effects on the optical quality of the composite pane. A cutout in one or both barrier films consequently results in improved optical quality. Furthermore, the thickness of the layer structure is reduced through removal of the barrier film in the region of the cutouts. The cutouts are preferably set back by at least 2 mm, particularly preferably by at least 5 mm, in the direction of the central area of the functional element from the edge of the functional element. The functional element and the barrier films thus overlap sheet-wise by at least this amount. This is advantageous for reliable sealing. The overlap region between the barrier films and the functional element is circumferential along the edges of the functional element. The width of the overlap region is preferably a maximum of 20 mm. For example, the overlap region can have a width of 10 mm.

According to the invention, the first and the second barrier film of the pre-composite are trimmed such that each barrier film has an overhang u protruding beyond the functional element and overhanging sections of the barrier film are arranged directly adjacent and touch each other at least in sections. The terms “overhang” or “to overhanging” mean, as generally used: to protrude beyond something in a lateral (horizontal) direction. In this case, the barrier film protrudes, in the plane of the functional element, beyond the functional element. Here, “lateral” means, as generally used: to the side or sideways.

The overhang u according to the invention consequently differs from the already described overlap region in which the barrier film is arranged directly on a section of the top or the underside of the functional element and overlaps with it.

Preferably, the cutouts and the back cut of the barrier films are done such that the first barrier film and/or the second barrier film form in each case the shape of a continuous circumferential frame. This is advantageous in terms of the dimensional stability of the barrier films in the pre-composite.

In a possible embodiment of the invention, in step c) a thermoplastic frame film is arranged between the first pane and the first thermoplastic laminating film and/or between the second pane and the second thermoplastic laminating film, which frame film surrounds the region of the intermediate layer, into which the functional element is introduced. The thermoplastic frame film is thus inserted circumferentially into the layer stack In the pane region beyond the side edges of the functional element. The frame film is frame-like with an opening into which the functional element surrounded by the pre-composites is inserted. The frame film can correspond in its nature and material composition to the first and/or the second thermoplastic laminating film, wherein the opening has been made by cutting. Alternatively, the thermoplastic frame film can also be composed of a plurality of film sections around the functional element. The outer side edges of the thermoplastic frame film are preferably arranged congruent with the side edges of the first and the second thermoplastic laminating film. The thermoplastic frame film can differ in its thickness from the thickness of the first and/or second laminating film. Preferably, the thickness of the thermoplastic frame film is selected such that it has approx. the same thickness as the functional element. Thus, the local difference in thickness of the windshield introduced by the locally limited functional element is compensated such that glass breakage during lamination can be avoided.

Since, according to the invention, the frame film is inserted between the first thermoplastic laminating film and the first pane and/or between the second thermoplastic laminating film and the second pane, the frame film has no direct contact with the functional element. The functional element is sealed on both sides by the first and the second barrier film by placement of bilayers. The frame film makes contact only with the adjacent pane and the thermoplastic laminating film of the adjacent bilayer and fuses with the thermoplastic laminating film during the laminating operation. The individual film components thus remain intact to the extent that they are still detectable even in the laminated composite pane.

In another preferred embodiment of the method according to the invention, no thermoplastic frame film is inserted into the layer stack. This is, for example, possible when the functional element has comparatively low thickness, and thus the local difference in thickness is small. However, the decision as to whether a frame film can be dispensed with also depends on the geometry of the composite pane to be produced. In particular, with complex geometries or strong bends in the edge region, even a small local difference in thickness can favor glass breakage. A general prediction regarding the difference in thickness above which a thermoplastic frame film should be used can thus not be made. As an empirical value, it has been found that with a local difference in thickness less than or equal to 150 μm, preferably less than or equal to 120 μm, a thermoplastic frame film can usually be dispensed with.

The first thermoplastic laminating film, the second thermoplastic laminating film, and/or the thermoplastic frame film contain, in each case, at least one plasticizer.

Plasticizers are chemical compounds that make plastics softer, more flexible, smoother, and/or more elastic. They shift the thermoelastic range of plastics to lower temperatures such that the plastics have the desired more elastic properties in the range of the temperature of use. Preferred plasticizers are carboxylic acid esters, in particular low-volatility carboxylic acid esters, fats, oils, soft resins, and camphor. Other plasticizers are preferably aliphatic diesters of tri- or tetraethylene glycol. Particularly preferably used as plasticizers are 3G7, 3G8, or 4G7, where the first digit indicates the number of ethylene glycol units and the last digit indicates the number of carbon atoms in the carboxylic acid portion of the compound. Thus, 3G8 represents triethylene glycol-bis-(2-ethyl hexanoate), in other words, a compound of the formula C₄H₉CH (CH₂CH₃) CO (OCH₂CH₂)₃O₂CCH (CH₂CH₃) C₄H₉.

Preferably, the first thermoplastic laminating film, the second thermoplastic laminating film, and/or the thermoplastic frame film contain at least 3 wt.-%, preferably at least 5 wt.-%, particularly preferably at least 20 wt.-%, even more preferably at least 30 wt.-%, and in particular at least 40 wt.-% of a plasticizer. Preferably, the plasticizer contains or is made of triethylene glycol-bis-(2-ethyl hexanoate).

Also preferably, the first thermoplastic laminating film, the second thermoplastic laminating film, and/or the thermoplastic frame film contain at least 60 wt.-%, particularly preferably at least 70 wt.-%, in particular at least 90 wt.-%, and, for example, at least 97 wt.-% polyvinyl butyral.

In an advantageous embodiment of the method according to the invention, the first and the second barrier film are selected such that they prevent the diffusion of plasticizers out of the intermediate layer through the barrier film.

In an advantageous embodiment of the method according to the invention, plasticizer-poor barrier films are selected, preferably with a plasticizer content of less than 3 wt.-%, particularly preferably of less than 1 wt.-%, and in particular of less than 0.5 wt.-%. Most particularly preferably, the barrier film is plasticizer-free, in other words, without deliberate addition of a plasticizer.

Particularly preferably, plasticizer-free plastics are used in the method according to the invention. The barrier films contain in particular polyethylene terephthalate (PET) or polyvinyl fluoride (PVF) or are made thereof. These materials are plasticizer-free, as a result of which the aging resistance of the functional element is further improved, compared to the use of plasticizer-poor barrier films.

The barrier film can alternatively also contain plasticizer-poor polyvinyl butyral (PVB) with a plasticizer content of less than 3 wt.-%.

In a particularly preferred embodiment of the method according to the invention, the material composition of the barrier film and of the thermoplastic laminating film differs within the pre-composite in terms of their main constituents by weight. The inventors were able to observe that with a similar choice of material of the components making direct contact, a certain diffusion of chemical compounds starting from the thermoplastic laminating film through the barrier film to the open edges of the functional element occurs. This is completely or almost completely prevented by selecting a material for the barrier film that differs from that of the thermoplastic laminating film not only in its plasticizer content but also in its main polymer constituent.

An embodiment including barrier films containing polyethylene terephthalate as the main constituent in combination with thermoplastic laminating films containing polyvinyl butyral as the main constituent has proved to be particularly advantageous in terms of restricting the diffusion of plasticizers and other chemical compounds.

The electrical contacting of the surface electrodes of the functional element is preferably done prior to lamination of the composite pane.

Any imprints, for example, opaque masking prints or printed bus bars for the electrical contacting of the functional element are preferably applied by screen printing.

The lamination is preferably done under the action of heat, vacuum, and/or pressure. Lamination methods known per se can be used, for example, autoclave methods, vacuum bag methods, vacuum ring methods, calender methods, vacuum laminators, or combinations thereof.

The invention further includes a composite pane containing a functional element having electrically controllable optical properties produced in the method according to the invention. The composite pane comprises, laminated in this order as a layer stack, a first pane, a first pre-composite comprising a first thermoplastic laminating film with at least one plasticizer and a first barrier film, a functional element, a second pre-composite comprising a second thermoplastic laminating film with at least one plasticizer and a second barrier film and a second pane. The first barrier film is in direct contact with the circumferential edge of the functional element. The first barrier film is thus positioned in the layer stack such that it covers at least the subregion of the functional element in which its circumferential edge lies, on a surface of the functional element. The second barrier film also is in direct contact with the circumferential edge of the functional element. The second barrier film is attached on the opposite surface of the functional element relative to the first barrier film and covers at least the subregion of the functional element in which the functional element has a circumferential edge. Since the barrier films are arranged sheet-wise directly adjacent the functional element in the region of the circumferential edge, they surround the circumferential open edge of the functional element after lamination of the composite pane. In the region adjacent the open edge of the functional element, the first and the second barrier film touch each other directly sheet-wise at least in sections. The circumferential region along the edge of the functional element, in which the the first and the second barrier film touch each other, has an overhang u protruding beyond the functional element. This refers to the common overhang of the barrier films. Irrespective of this, a single one of the barrier films can also protrude farther beyond the functional element.

The method according to the invention enables production of a composite pane according to the invention that has improved sealing of the circumferential edge without requiring gluing the barrier films to the adjacent film components (thermoplastic laminating film, other barrier film) or to the functional element. This absence of adhesives or other point-wise fixation of the barrier films is evident from the composite pane.

The first barrier film and the second barrier film are preferably implemented in each case in the form of a continuous circumferential frame. In this context, “continuous” means that the barrier film in question surrounding the functional element is interruption-free, i.e., has no breaks. The frame results from the circumferential back cut of the barrier films as well as the cutout in the region of the functional element. The frame-like shape is advantageous in terms of the dimensional stability of the barrier films in the pre-composite. Moreover, improved sealing can be achieved by means of a gapless continuous shaping. By comparison, with the use of individual sections of a barrier film, placed in each case along the edges of the functional element, quality problems can occur. For example, air inclusions can occur in the overlapping regions of the individual strip-shaped sections of the barrier films or the plasticizer-containing material of the thermoplastic laminating films can penetrate into these regions if there is insufficient overlap. A sheet-wise continuous frame-like embodiment of the barrier films along the edges of the functional element is thus advantageous both in terms of simplified production and product quality.

The statements already made in the description of the method according to the invention with regard to the composite pane resulting from the method apply, of course, to the pane itself.

The composite pane can, for example, be the windshield or the roof panel of a vehicle or another vehicle glazing, for example, a glass partition in a vehicle, preferably in a rail vehicle or a bus. Alternatively, the composite pane can be an architectural glazing, for example, in an outer facade of a building or a glass partition in the interior of a building.

The terms “outer pane” and “inner pane” arbitrarily describe two different panes. In particular, the outer pane can be referred to as a first pane; and the inner pane, as a second pane.

In the context of the invention, when the composite pane is intended, in a window opening of a vehicle or of a building, to separate an interior space from the external environment, the pane (second pane) facing the interior (vehicle interior) is referred to as the “inner pane”. The pane (first pane) facing the external environment is referred to as the “outer pane”. However, the invention is not limited to this.

The composite pane according to the invention contains a functional element having electrically controllable optical properties, which is arranged between a first thermoplastic laminating film and a second thermoplastic laminating film at least in sections. The first and second thermoplastic laminating film usually have the same dimensions as the first and the second pane. The functional element is preferably film-like.

In an advantageous embodiment of a composite pane according to the invention, the overhang u of the barrier film protruding beyond the functional element is at least 1 mm, preferably at least 2 mm, particularly preferably at least 5 mm, and in particular at least 8 mm, for example, 10 mm. The overhang u is thus determined in its lateral dimension parallel to the two largest dimensions of the functional element or of the composite pane.

In an advantageous embodiment of a composite pane according to the invention, the overhang u of the barrier film beyond the functional element is less than 50 mm, preferably less than 30 mm, and particularly preferably less than 20 mm.

The thickness of the thermoplastic laminating films is in each case preferably from 0.2 mm to 2 mm, particularly preferably from 0.3 mm to 1 mm, in particular from 0.3 mm to 0.5 mm, for example, 0.38 mm.

The thickness of the barrier films is in each case 10 μm to 150 μm, preferably 15 μm to 100 μm, particularly preferably 20 μm to 70 μm, for example, 25 μm or 50 μm. Such thin film thicknesses are advantageous in order to increase the local difference in thickness between the intermediate layer with a functional element and the intermediate layer without a functional element only as little as possible. This has a positive effect in terms of limiting the stresses resulting from the difference in thickness.

The controllable functional element typically comprises an active layer between two surface electrodes. The active layer has the controllable optical properties that can be controlled via the voltage applied to the surface electrodes. The surface electrodes and the active layer are typically arranged substantially parallel to the surfaces of the first pane and the second pane. The surface electrodes are electrically connected to an external voltage source in a manner known per se. The electrical contacting is realized by means of suitable connecting cables, for example, foil conductors that are optionally connected to the surface electrodes via so-called bus bars, for example, strips of an electrically conductive material or electrically conductive imprints.

The surface electrodes are preferably designed as transparent, electrically conductive layers. The surface electrodes preferably contain at least a metal, a metal alloy, or a transparent conducting oxide (TCO). The surface electrodes can contain, for example, silver, gold, copper, nickel, chromium, tungsten, indium tin oxide (ITO), gallium-doped or aluminum-doped zinc oxide, and/or fluorine-doped or antimony-doped tin oxide. The surface electrodes preferably have a thickness of 10 nm to 2 μm, particularly preferably from 20 nm to 1 μm, most particularly preferably from 30 nm to 500 nm.

The functional element can have, besides the active layer and the surface electrodes, other layers known per se, for example, barrier layers, blocking layers, antireflection layers, protective layers, and/or smoothing layers.

The functional element is preferably present as a multilayer film with two outer carrier films. In such a multilayer film, the surface electrodes and the active layer are arranged between the two carrier films. Here, “outer carrier film” means that the carrier films form the two surfaces of the multilayer film. The functional element can thus be provided as a laminated film that can be processed advantageously. The functional element is advantageously protected by the carrier films against damage, in particular corrosion. The multilayer film contains, in the order indicated, at least one carrier film, one surface electrode, one active layer, another surface electrode, and another carrier film. The carrier film carries, in particular, the surface electrodes and gives a liquid or soft active layer the necessary mechanical stability.

The carrier films preferably contain at least one thermoplastic polymer, particularly preferably plasticizer-poor or plasticizer-free polyethylene terephthalate (PET). This is particularly advantageous in terms of the stability of the multilayer film. The carrier films can, however, also contain or be made of other plasticizer-poor or plasticizer-free polymers, for example, ethylene vinyl acetate (EVA), polypropylene, polycarbonate, polymethyl methacrylate, polyacrylate, polyvinyl chloride, polyacetate resin, casting resins, acrylates, fluorinated ethylene propylenes, polyvinyl fluoride, and/or ethylene-tetrafluoroethylene. The thickness of each carrier film is preferably from 0.1 mm to 1 mm, particularly preferably from 0.1 mm to 0.2 mm. In particular, the carrier films contain or are made of plasticizer-free polyethylene terephthalate.

Typically, the carrier films have in each case an electrically conductive coating that faces the active layer and functions as a surface electrode.

In another advantageous embodiment of a composite pane according to the invention, the functional element is a PDLC functional element (polymer dispersed liquid crystal). The active layer of a PDLC functional element contains liquid crystals that are embedded in a polymer matrix. When no voltage is applied on the surface electrodes, the liquid crystals are oriented in a disorderly fashion, resulting in strong scattering of the light passing through the active layer. When a voltage is applied on the surface electrodes, the liquid crystals align themselves in a common direction and the transmittance of light through the active layer is increased.

In principle, however, it is also possible to use other types of controllable functional elements, for example, electrochromic functional elements or SPD functional elements (suspended particle device). The controllable functional elements mentioned and their mode of operation are known per se to the person skilled in the art such that a detailed description can be dispensed with here.

Functional elements as multilayer films are commercially available. The functional element to be integrated is typically cut in the desired shape and size from a multilayer film of relatively large dimensions. This can be done mechanically, for example, with a knife. In an advantageous embodiment, the cutting is done using a laser. It has been demonstrated that, in this case, the side edge is more stable than with mechanical cutting. With mechanically cut side edges, there can be a risk that the material will pull back, which is visually conspicuous and adversely affects the aesthetics of the pane.

The functional element is joined to the first pane via a region of the first thermoplastic laminating film and to the inner pane via a region of the second thermoplastic laminating film.

The first and the second thermoplastic laminating film are preferably arranged sheet-wise one over another and laminated together, with the functional element inserted between the two layers. The regions of the thermoplastic laminating films overlapping the functional element then form the regions that connect the functional element to the panes. In other regions of the pane where the thermoplastic laminating films make direct contact with one another, they can fuse during lamination.

The composite pane according to the invention can contain one first thermoplastic laminating film and one second thermoplastic laminating film or even a plurality of first and/or second thermoplastic laminating films. Consequently, instead of a first and/or second thermoplastic laminating film, there can also be in each case a two-ply, three-ply, or multi-ply film stack comprising thermoplastic laminating films and/or other functional films, wherein the individual films have the same or different properties. A thermoplastic laminating film can also be formed from sections of different thermoplastic films whose lateral edges are adjacent.

In an advantageous further development of a composite pane according to the invention, the region of the thermoplastic laminating films via which the functional element is joined to the first pane and/or the second pane is tinted or colored. The transmittance of this region in the visible spectral range is thus reduced compared to a non-tinted or non-colored layer. The tinted/colored region of the intermediate layer of thus reduces the transmittance of the windshield in the region of the sun visor. In particular, the aesthetic impression of the functional element is improved because the tinting results in a neutral appearance that affects the observer more pleasantly.

This tinting or coloring of the composite pane can be achieved by multiple measures that can also be combined with each other as needed. Generally speaking, it is possible to manufacture the first and/or the second pane from tinted or colored glass. Furthermore, the first and/or the second thermoplastic laminating film, which can be used according to the invention in each case in the form of a bilayer with a barrier film, can be tinted or colored. This can also apply to the thermoplastic frame film. Moreover, in addition to the first and second thermoplastic laminating film, other tinted or colored films can be inserted into the layer stack. Films in which the tinted or colored region is produced by local tinting or coloring can also be used as a first, second, or even a further thermoplastic laminating film. Such films can, for example, be obtained by coextrusion. Alternatively, a non-tinted film section and a tinted or colored film section can be combined to form the thermoplastic layer.

The tinted or colored region of the intermediate layer preferably has transmittance in the visible spectral range of 10% to 50%, particularly preferably of 20% to 40%. Particularly good results in terms of glare protection and optical appearance are thus obtained.

The tinted or colored region can be colored or tinted homogeneously, in other words, can have location-independent transmittance. The tinting or coloring can, however, also be inhomogeneous; in particular, a transmittance progression can be realized. In an embodiment, the transmittance level in the tinted or colored region decreases, at least in sections, with increasing distance from the upper edge. Thus, sharp edges of the tinted or colored area can be avoided such that the transition from a PDLC functional element used as a sun visor into the transparent region of the windshield is gradual, which appears more attractive aesthetically.

In an advantageous embodiment, the first pane is the outer pane, and the region of the first thermoplastic laminating film, i.e., the region between the functional element and the outer pane is tinted. This creates a particularly aesthetic impression when the outer pane is viewed from above. Optionally, the region of the second thermoplastic laminating film between the functional element and the inner pane (second pane) can be additionally colored or tinted.

In a preferred embodiment of the composite pane according to the invention, the first and the second thermoplastic laminating film are tinted and are used according to the invention as a bilayer with a barrier film in each case. Between the first pane (here: outer pane) and the first thermoplastic laminating film, a carrier film with an infrared reflecting coating, followed by a further thermoplastic laminating film, is inserted into the layer stack. The carrier film with an infrared reflecting coating is bonded via the first thermoplastic laminating film onto the functional element after lamination of the layer stack, while the bonding to the first pane is done via the further thermoplastic laminating film. The second thermoplastic laminating film ensures bonding to the second pane either directly or with interpositioning of a thermoplastic frame film. Such a structure is, for example, advantageous as a roof panel of a motor vehicle since the infrared reflecting coating reduces the undesirable heating of the vehicle interior by solar radiation. In addition to the attractive design of the composite pane already mentioned, the tinted thermoplastic laminating films also contribute to reducing the solar radiation. In another advantageous variant of this exemplary embodiment, a polymeric metal-free film, which itself has infrared reflecting properties, is used instead of a carrier film with an infrared reflecting coating. Such polymeric films without metallic constituents are commercially available. The infrared reflecting effect is created by a sequence of a plurality of polymeric layers, on whose interfaces a partial reflection occurs in each case.

In the context of the invention, “electrically controllable optical properties” means those properties that are infinitely controllable but also those that can be switched between two or more discrete states.

The electrical control of the sun visor or of the switchable vehicle roof glazing is done, for example, using switches, rotary knobs, or sliders that are integrated into the dashboard of the vehicle. However, a switch area, for example, a capacitive switch area, for controlling the sun visor can also be integrated into the windshield or into the roof surface. Alternatively, or additionally, the sun visor can be controlled by contactless methods, for example, by gesture recognition, or as a function of the pupil or eyelid state detected by a camera and suitable evaluation electronics. Alternatively, or additionally, the sun visor can be controlled by sensors that detect light incidence on the pane.

The composite pane having an electrically controllable functional element can advantageously be implemented as a windshield or roof panel with an electrically controllable sun visor.

A windshield has an upper edge and a lower edge as well as two side edges extending between the upper edge and the lower edge. “Upper edge” refers to that edge that is intended to point upward in the installation position. “Lower edge” refers to that edge that is intended to point downward in the installation position. The upper edge is often referred to as the “roof edge”; the lower edge, as the “engine edge”.

A motor vehicle roof panel has a front edge that points toward the windshield and a rear edge that points in the direction of the rear window of the vehicle. The remaining edges of the roof panel are the side edges. The side edges extend between the front edge and the rear edge of the pane.

Windshields have a central field of vision, the optical quality of which is subject to high requirements. The central field of vision must have high light transmittance (typically greater than 70%). Said central field of vision is, in particular, that field of vision that is referred to by the person skilled in the art as field of vision B, vision area B, or zone B. The field of vision B and its technical requirements are specified in Regulation No. 43 of the Economic Commission for Europe of the United Nations (UN/ECE) (ECE-R43, “Uniform Provisions concerning the Approval of Safety Glazing Materials and Their Installation on Vehicles”). There, the field of vision B is defined in Annex 18.

In a windshield, the functional element is advantageously arranged above the central field of vision (field of vision B). This means that the functional element is arranged in the region between the central field of vision and the upper edge of the windshield. The functional element does not have to cover the entire area, but is positioned completely within this area, and does not protrude into the central field of vision. In other words, the functional element is less distant from the upper edge of the windshield than the central field of vision. Thus, the transmittance of the central field of vision is not adversely affected by the functional element which is positioned in a location similar to that of a conventional mechanical sun visor in the folded-down state.

The windshield is preferably provided for a motor vehicle, particularly preferably for a passenger car.

In a preferred embodiment of a windshield according to the invention, the lower edges of the functional element and of the tinted region of the intermediate layer(s) are adapted to the shape of the upper edge of the windshield, yielding a more appealing visual impression. Since the upper edge of a windshield is typically curved, in particular concavely curved, the lower edge of the functional element and of the tinted region is also preferably curved. Particularly preferably, the lower edges of the functional element are substantially parallel to the upper edge of the windshield. It is, however, also possible to construct the sun visor from two halves, each straight, arranged at an angle relative to one another, and forming a virtually V-shaped upper edge.

In one embodiment of the invention, the functional element is divided into segments by isolation lines. The isolation lines are in particular introduced into the surface electrodes such that the segments of the surface electrode are isolated from one another. The individual segments are connected to the voltage source independently of one another such that they can be actuated separately. Thus, different regions of the sun visor can be switched independently. Particularly preferably, the isolation lines and the segments are arranged horizontally in the installation position. Thus, the height of the sun visor can be controlled by the user. The term “horizontal” is to be interpreted broadly here and refers to a direction of extension that, in a windshield, runs between the side edges of the windshield. The isolation lines do not necessarily have to be straight, but can also be slightly curved, preferably adapted to possible curvature of the upper edge of the windshield, in particular substantially parallel to the upper edge of the windshield. Vertical isolation lines are, of course, also conceivable.

The isolation lines have, for example, a width of 5 μm to 500 μm, in particular 20 μm to 200 μm. The width of the segments, i.e., the distance between adjacent isolation lines can be suitably selected by the person skilled in the art according to the requirements of the individual case.

The isolation lines can be introduced by laser ablation, mechanical cutting, or etching during production of the functional element. Already laminated multilayer films can also be subsequently segmented by laser ablation.

Functional elements in roof panels are usually switched as complete areas. However, the roof panel according to the invention can also, as described for the windshield, be divided by isolation lines into individual switchable segments.

The upper edge and the side edges or all side edges of the functional element are concealed in through-vision through the composite pane preferably by an opaque masking print or by an outer frame. Windshields and roof panels typically have a circumferential peripheral masking print made of an opaque enamel, which serves in particular to protect the adhesive used for installation of the pane against UV radiation and to visually conceal it. This peripheral masking print is preferably used to also conceal the upper edge and the side edge of the functional element as well as the necessary electrical connections. The functional element is then advantageously integrated into the appearance of the pane. Only in the case of sun visors is the lower edge potentially discernible to the observer. Preferably, both the outer pane and also the inner pane have a masking print such that through-vision in the edge region is prevented from both sides.

The functional element can also have recesses or holes, for instance, in the region of so-called sensor windows or camera windows. These regions are provided to be equipped with sensors or cameras whose function would be impaired by a controllable functional element in the beam path, for example, rain sensors. It is also possible to realize the sun visor with at least two functional elements separated from one another, with a distance between the functional elements providing space for sensor windows or camera windows.

The functional element (or the totality of the functional elements in the above-described case of a plurality of functional elements) is preferably arranged over the entire width of the composite pane, minus an edge region having a width of, for example, 2 mm to 20 mm. The functional element is thus encapsulated within the intermediate layer and protected against contact with the surrounding atmosphere and corrosion.

The first and the second pane are preferably made of glass, particularly preferably of soda lime glass, as is customary for window panes. The panes can, however, also be made of other types of glass, for example, quartz glass, borosilicate glass, or aluminosilicate glass, or rigid clear plastics, for example, polycarbonate or polymethyl methacrylate. The panes can be clear, or also tinted or colored. Windshields must have adequate light transmittance in the central field of vision, preferably at least 70% in the primary through-vision zone A per ECE-R43.

The first pane, the second pane, and/or the intermediate layer can have further suitable coatings known per se, for example, antireflection coatings, nonstick coatings, anti-scratch coatings, photocatalytic coatings, or solar protection coatings, or low-E coatings.

The thickness of the first and the second pane can vary widely and thus be adapted to the requirements of the individual case. The first and the second pane preferably have thicknesses of 0.5 mm to 5 mm, particularly preferably of 1 mm to 3 mm.

The invention further includes the use of a composite pane according to the invention having an electrically controllable functional element as interior glazing or exterior glazing in a vehicle or a building, wherein the electrically controllable functional element is used as a sun screen or as a privacy screen.

The invention further includes the use of a composite pane according to the invention as a windshield or roof panel of a vehicle, wherein the functional element is used as a sun visor.

A major advantage of the invention consists in that with composite panes as a windshield, it is possible to dispense with a conventional mechanically foldable sun visor mounted on the vehicle roof.

The invention is explained in detail with reference to drawings and exemplary embodiments. The drawings are schematic representations and not to scale. The drawings in no way restrict the invention. They depict:

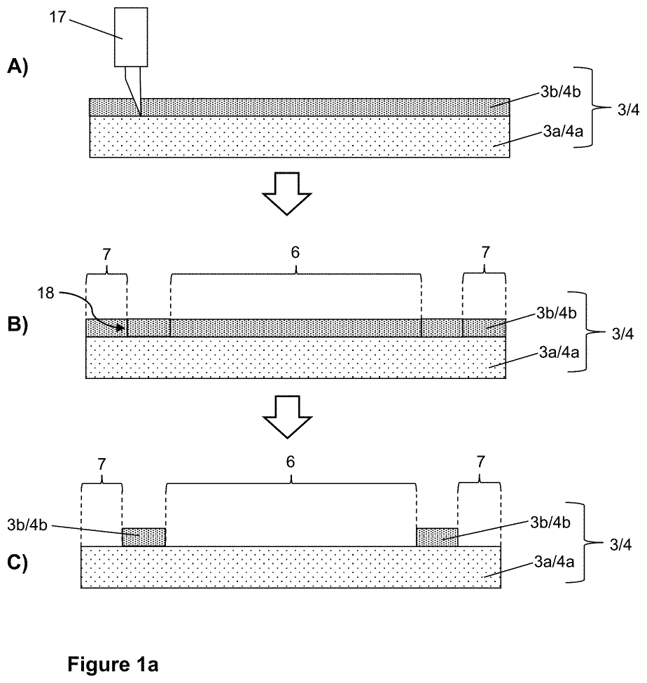

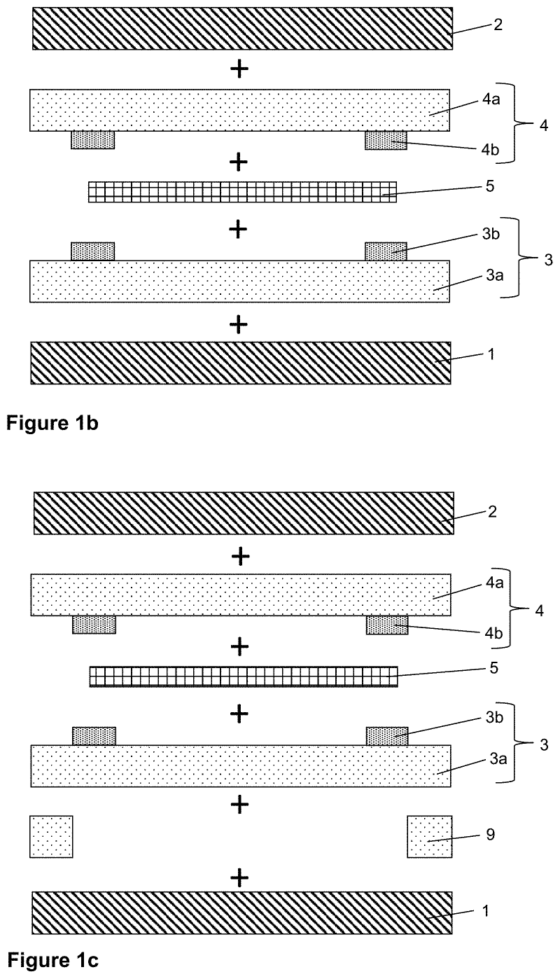

FIG. 1a a cross-section of a pre-composite comprising barrier film and thermoplastic laminating film during cutting of the film to size,

FIG. 1b a layer stack of an embodiment of the composite pane according to the invention prior to lamination of the pane,

FIG. 1c a layer stack of another embodiment of the composite pane according to the invention with a thermoplastic frame film prior to lamination of the pane,

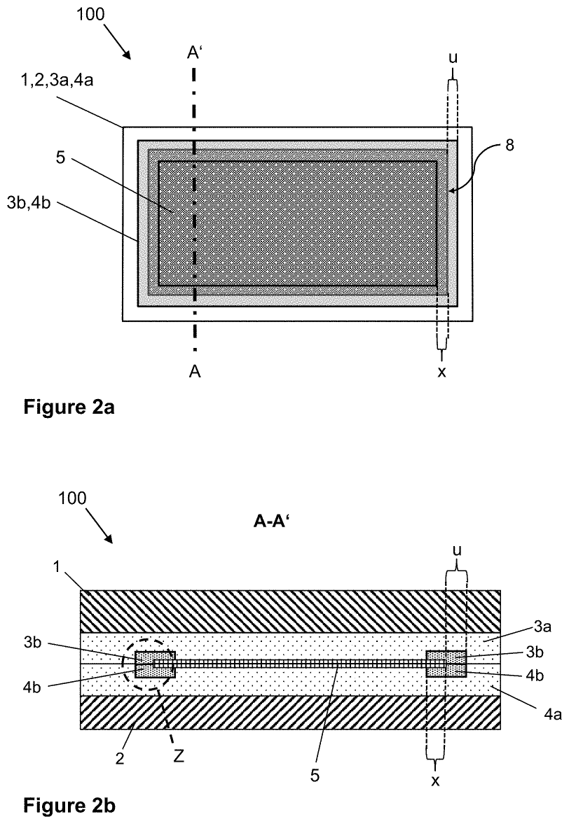

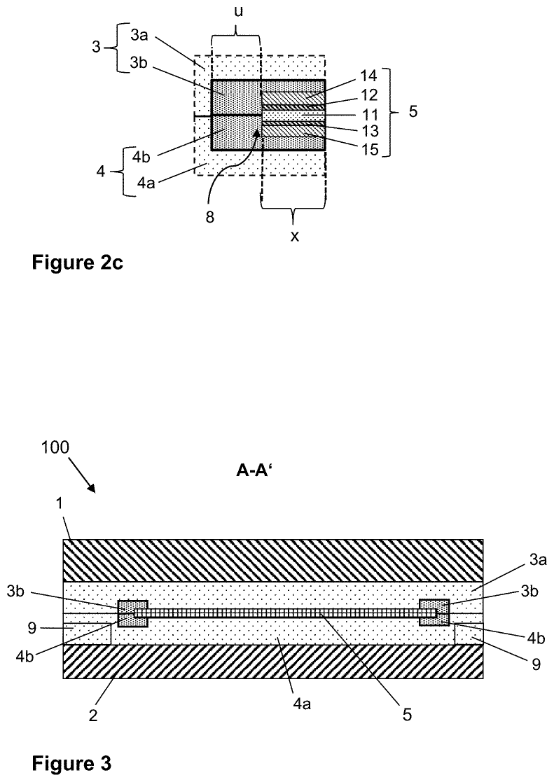

FIG. 2a a plan view of an embodiment of the composite pane according to the invention,

FIG. 2b a cross-section through the composite pane of FIG. 2a along the section line A-A′,

FIG. 2c an enlarged representation of the region Z of FIG. 2b,

FIG. 3 a cross-section through an embodiment of the composite pane according to the invention with a thermoplastic frame film,

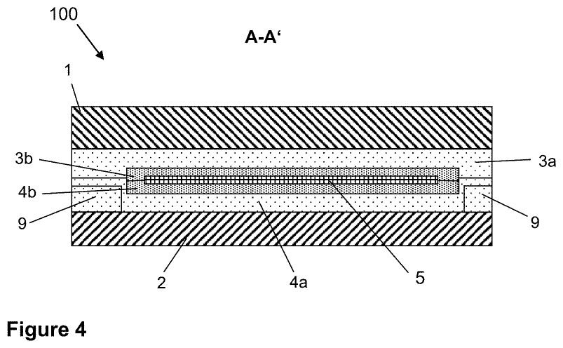

FIG. 4 a cross-section through another embodiment of the composite pane according to the invention with a thermoplastic frame film,

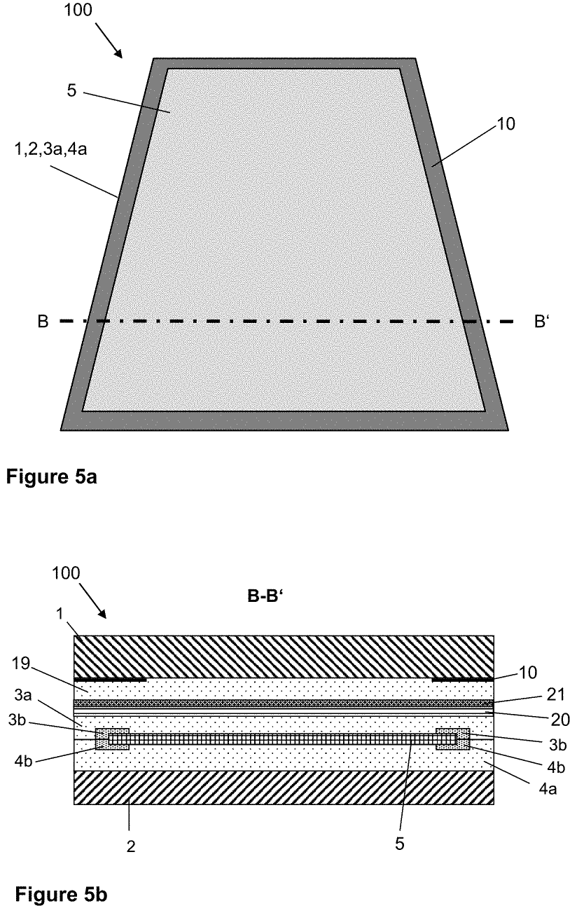

FIG. 5a a plan view of another embodiment of a composite pane according to the invention as a roof panel with a functional element,

FIG. 5b a cross-section through the composite pane of FIG. 5a along the section line B-B′,

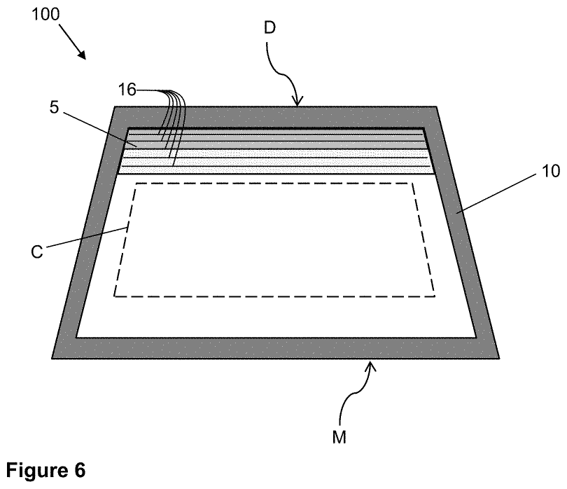

FIG. 6 a plan view of another embodiment of a composite pane according to the invention as a windshield with a sun visor.

FIG. 1a depicts a pre-composite 3 or 4 according to the invention comprising a thermoplastic laminating film 3a or 4a and a barrier film 3b or 4b and the processing steps for cutting the barrier film to size, represented as states A to C. This can, analogously, be a composite 3 of the first thermoplastic laminating film 3a with the first barrier film 3b, or a composite 4 of the second thermoplastic laminating film 4a with the second barrier film 4b. The pre-composites 3 or 4 per state A) in FIG. 1a were produced by routing a thermoplastic laminating film 3a or 4a together with a barrier film 3b or 4b through a heated pair of rollers with a temperature of 45° C. and a speed of 4 m/min. The rollers press the films together under heating, bonding them to form a pre-composite. The thermoplastic laminating films 3a and 4a are made of 78 wt.-% polyvinyl butyral (PVB) and 20 wt.-% triethylene glycol bis(2-ethyl hexanoate) as plasticizer and have in each case a thickness of 0.38 mm, while the barrier films 3b and 4b are made substantially of polyethylene terephthalate (PET) and are in each case 50 μm thick. Here, the barrier film 3b and 4b are made, for example, substantially of PET, i.e., at a rate of at least 97 wt.-%. The barrier films 3b and 4b contain less than 0.5 wt.-% plasticizer and are preferably plasticizer-free. The barrier films 3b, 4b are suitable to decisively reduce or prevent the diffusion of plasticizer out of thermoplastic laminating films 3a, 4a. The pre-composites 3 and 4 can be constructed with the same or different materials and film thicknesses. In such a pre-composite 3 or 4, cuts 18 are made in the barrier film 3b or 4b of the pre-composite 3, 4 using a cutting tool 17. The cutting depth is selected such that the thermoplastic laminating film remains substantially undamaged. The cuts 18 made in the barrier film 3b, 4b produce a back cut 7 in the edge region of the barrier films 3b, 4b, as a result of which the barrier films 3b, 4b are set back relative to the circumferential edge of the subsequent composite pane. Furthermore, a cutout 6 is produced within the surface of the barrier films 3b, 4b. The cuts 18 necessary for the back cut 7 in the edge region as well as the cutout 6 within the surface of the barrier films 3b, 4b are depicted in state B) of FIG. 1a and run circumferentially. Suitable cutting tools 17 are known to the person skilled in the art. A plotter equipped with a cutting blade has, for example, proved to be quite suitable. However, other methods can also be used, such as laser cutting. The barrier films 3b, 4b are removed in the region of the cut back 7 and of the cutout 6. This is possible by lifting the barrier film 3b, 4b to be detached at the edge of a cut 18. Starting from such a raised corner, the regions of the barrier film 3b, 4b to be removed are peeled off. This is possible with moderate expenditure of force and without damaging the films. This creates a pre-composite 3, 4 comprising a continuous thermoplastic laminating film 3a, 4a and a frame-shaped barrier film 3b, 4b, that is present only at the locations on the pre-composite where it is necessary for the sealing of the functional element (see C) in FIG. 1a). A single barrier film 3b, 4b trimmed to a frame shape has no dimensional stability at all such that it cannot be handled by machine and can hardly be handled manually. Through the use according to the invention of a bilayer (pre-composites 3, 4), the barrier films 3b, 4b can be cut in any geometries without any restrictions. The stability and handleability of the assembly is, consequently, always ensured by the thermoplastic laminating film 3a, 4a.

Accordingly, the use of bilayers is decisive for the ability to automate the process as well as for the variable shaping of the functional element.

FIG. 1b depicts a layer stack for producing the composite pane according to the invention using the pre-composite per FIG. 1a. The plus signs situated between the plies of the layer stack indicate the layer sequence in which the components are arranged on one another. A bilayer (pre-composite 3 per FIG. 1a) comprising a first thermoplastic laminating film 3a and a first barrier film 3b present on subregions of the laminating film 3a is placed on a first pane 1 made of clear soda lime glass with a thickness of 2.1 mm. The thermoplastic laminating film 3a is placed adjacent the first pane 1. The first pane 1 per FIG. 1b has a thickness of 2.1 mm and represents the outer pane of the windshield of a motor vehicle. A functional element 5 is placed on the first barrier film 3a, with the barrier film 3a and the functional element 5 coordinated with one another in their dimensioning such that the circumferential edge of the functional element 5 rests on the surface of the barrier film 3a. The functional element is implemented as a PDLC element with a thickness of 100 μm. Another bilayer (pre-composite 4 per FIG. 1a) which points with a second barrier layer 4b in the direction of the functional element 5, is applied on the functional element 5. A second pane 2 is placed above the second thermoplastic laminating film 4a, completing the layer stack. The second pane 2 has a thickness of 1.6 mm and is also made, for example, of clear soda lime glass. In this case, the second pane 2 represents the inner pane of a windshield and is bent congruently together with the first pane. The barrier films 3b, 4b are trimmed per FIG. 1 a such that they are substantially congruent with one another per FIG. 1b and, together, cover the circumferential edge of the functional element 5. Any additional films, for example, functional films or colored films, can be arranged between the first thermoplastic laminating film 3a and the first pane 1 or between the second thermoplastic laminating film 4a and the second pane 2. The pre-composites 3, 4 remain in the vicinity of the functional element 5 with direct contact between the functional element 5 and the barrier films 3b, 4b, even if the layer stack is extended. Such a layer stack can be assembled by machine. The use of pre-composites thus represents a significant simplification in terms of the production process of the composite pane.

FIG. 1c depicts a layer stack for producing the composite pane according to the invention using the pre-composite per FIG. 1a. The structure of the layer stack corresponds substantially to that described in FIG. 1b. In contrast thereto, the functional element 5 has a thickness of 400 μm. In order to compensate for the difference in thickness between the region of the composite pane with a functional element 5 and the region of the composite pane without a functional element 5, a frame-shaped thermoplastic laminating film 9 with a thickness of 0.38 mm is inserted into the layer stack. This can, for example, be arranged adjacent the first pane 1 or adjacent the second pane 2. The laminating film 9 corresponds in its composition to the composition of the thermoplastic laminating films 3a and 4a already described (FIG. 1a).

FIG. 2a depicts an embodiment of a composite pane 100 according to the invention comprising a first pane 1, a second pane 2, a first thermoplastic laminating film 3a, a second thermoplastic laminating film 4a, a first barrier layer 3b, a second barrier layer 4b, and a functional element 5. FIG. 2b depicts a cross-section of the composite pane per FIG. 2a along the section line A-A′. An enlargement of the region Z of FIG. 2b is presented in FIG. 2c. The composite pane 100 can, for example, be arranged as architectural glazing in the frame of a window with additional panes to form an insulating glazing unit. The first and the second pane 1, 2 are made of clear soda lime glass with a thickness of 2.0 mm in each case. The first pane 1 and the second pane 2 are joined to one another via the first thermoplastic laminating film 3a and the second thermoplastic laminating film 4a. A functional element 5, which is also bonded to the panes 1, 2 via the thermoplastic laminating films 3a, 4a, is inserted between the first thermoplastic laminating film 3a and the second thermoplastic laminating film 4a. A first barrier film 3b and a second barrier film 4b, which surround the circumferential edge 8, are arranged along the circumferential edge 8. For this purpose, the first barrier film 3b and the second barrier film 4b are positioned directly against opposite surfaces of the functional element 5. The barrier films 3b, 4b are positioned substantially congruent to one another and have an overlap x (see FIG. 2a, 2b) of 10 mm with the functional element. Moreover, the barrier films 3b, 4b have an overhang u (see FIG. 2a, 2b) of 10 mm beyond the circumferential edge 8 of the functional element 5. Here, the barrier films 3b, 4b have, for example, an overhang u on all sides and an overlap x protruding on all sides beyond the functional element 5. Here, “on all sides” means that the overhang u and the overlap x are present on every side edge of the circumferential edge 8. In the region of the overhang u, the surfaces of the first barrier film 3b and the second barrier film 4b touch each other directly. Thus, the circumferential edge 8 of the functional element 5 is completely enclosed by the barrier films 3b, 4b. The barrier films 3b, 4b are formed as circumferentially continuous frame-shaped films. Due to the use of the barrier films 3b, 4b as pre-composites 3, 4 with the thermoplastic laminating films 3a, 4a, such complex geometries of the barrier films are possible and can be readily handled. The overhang u and the overlap x further improve the sealing of the circumferential edge 8 such that, in aging tests, the composite pane 100 with a functional element 5 showed either no brightening or hardly any visually perceptible brightening in the edge region of the functional element 5. According to the invention, diffusion of the plasticizer out of the thermoplastic laminating films 3a, 4a into the functional element 5 and degradation of the functional element 5 associated therewith are avoided.

The optical properties of the functional element 5 can be controlled by applying an electrical voltage. For the sake of simplicity, the electrical supply lines are not shown.

The controllable functional element 5 is, for example, a PDLC multilayer film, consisting of an active layer 11 between two surface electrodes 12, 13 and two carrier films 14, 15. The active layer 11 contains a polymer matrix with liquid crystals dispersed therein, which align themselves as a function of the electrical voltage applied on the surface electrodes, by which means the optical properties can be controlled. The carrier films 14, 15 are made of PET and have a thickness of, for example, 50 μm. The carrier films 14, 15 are provided with a coating of ITO facing the active layer 11 and having a thickness of approx. 100 nm, forming the surface electrodes 12, 13. The surface electrodes 12, 13 can be connected to a voltage source via bus bars (not shown) (implemented, for example, by a silver-containing screen print) and connecting cables (not shown).

The thermoplastic laminating films 3a, 4a comprise in each case a thermoplastic film with a thickness of 0.38 mm and are made, for example, of 78 wt.-% polyvinyl butyral (PVB) and 20 wt.-% triethylene glycol bis(2-ethyl hexanoate) as a plasticizer.

The barrier films 3b, 4b are made, here, for example, substantially of PET, i.e., at a rate of at least 97 wt.-%. The barrier films 3b, 4b contain less than 0.5 wt.-% plasticizer and are suitable for preventing the diffusion of plasticizer out of the thermoplastic laminating layers 3a, 4a via the circumferential edge 8 into the functional layer 5.

The barrier films 3b, 4b are in direct contact with the functional element 5, in the present case, in sheet-wise contact with the surfaces of the carrier films 14, 15, as well as, additionally, direct contact with the open cross-section of the functional element 5 along the circumferential edge 8. In the region of the overhang x, the barrier films 3b, 4b are in direct sheet-wise contact with one another. Here, the term “in direct contact” means that no other components or chemical compounds at all, for example, adhesives, are arranged between the barrier films 3b, 4b and between the barrier films and the functional element 5. According to the prior art, slippage of the barrier films during assembly is prevented by an adhesive connection.

According to the invention, an adhesive connection is unnecessary and undesirable. Slippage of the adhesive films is achieved through the use of pre-composites 3, 4, comprising in each case a barrier film 3b, 4b and a thermoplastic laminating film 3a, 4a. The embodiment of the invention described in FIGS. 2a, 2b, and 2c includes pre-composites 3, 4 produced per FIG. 1a. The use of pre-composites ensures not only a shifting of the barrier film in the layer stack but also facilitates the assembly of the layer stack. At the same time, inclusions of air bubbles and resultant optical defects or adverse effects are avoided since the barrier films 3b, 4b rest evenly on the functional element 5. The barrier films 3b, 4b according to the invention in the region of the circumferential edge of the functional element 5 are firmly pressed and fixed against one another by the inner pressure in the finished laminated composite pane 100, as a result of which hermetic sealing occurs even without use of adhesives. This was unexpected and surprising for the person skilled in the art.

FIG. 3 depicts a further development of the composite pane 100 according to the invention of FIGS. 2a, 2b, and 2c. The composite pane 100 of FIG. 3 corresponds substantially to the composite pane 100 of FIGS. 2a, 2b, and 2c such that, in the following, only the differences are discussed.

In this embodiment, a thermoplastic frame film 9 is arranged in sections between the second thermoplastic laminating film 4a and the second pane 2. The thermoplastic frame film 9 is made, for example, of the same material as the thermoplastic laminating films 3a, 4a. The thermoplastic frame film 9 has a cutout, into which the functional element 5 with the barrier films 3b, 4b and the thermoplastic laminating films 3a, 4a is inserted precisely, i.e., flush on all sides. The thermoplastic frame film 9 thus forms a sort of passe-partout for the functional element 5 and the film sections of the laminating film and barrier films surrounding it. By means of the thermoplastic frame film 9, the differences in thickness caused by the material thickness of the functional element 5 can be compensated. The thicknesses of the functional element 5 and of the thermoplastic frame film correspond to the values described in FIG. 1c.

FIG. 4 depicts another embodiment of the composite pane 100 according to the invention per FIG. 3. The composite pane 100 of FIG. 4 corresponds substantially to the composite pane 100 of FIG. 3, wherein the barrier films 3b, 4b have no cutouts 6. As a result, the entire functional elements 5 are enclosed by the barrier films 3b, 4b.

FIG. 5a depicts a plan view of an embodiment according to the invention of a composite pane 100 as a roof panel of a motor vehicle. FIG. 5b depicts a cross-section of the roof panel per FIG. 5a along the section line BB′. The roof panel comprises a first pane 1, a second pane 2, a first thermoplastic laminating film 3a, a second thermoplastic laminating film 4a, a first barrier layer 3b, a second barrier layer 4b, and a functional element 5. The first and the second pane 1, 2 are bent congruently with one another. The first pane 1 is the outer pane of the glazing, in other words, it is oriented toward the vehicle's surroundings, whereas the second pane 2 is the inner pane of the composite pane and points toward the vehicle interior. The first pane 1 is made of clear soda lime glass with a thickness of 2.1 mm. The second pane 2 is made of soda lime glass with a thickness of 1.6 mm and is tinted gray. The tinted inner glass contributes to the attractive appearance of the pane, even for the vehicle occupant when looking through the roof panel. The first pane 1 and the second pane 2 are joined to one another via the first thermoplastic laminating film 3a, the second thermoplastic laminating film 4a, and an additional thermoplastic laminating film 19. A functional element 5 that is also bonded to the panes 1, 2 via the thermoplastic laminating films 3a, 4a is inserted between the first thermoplastic laminating film 3a and the second thermoplastic laminating film 4a. A first barrier film 3b and a second barrier film 4b that enclose the circumferential edge 8 are arranged along the circumferential edge 8 of the functional element. For this purpose, the first barrier film 3b and the second barrier film 4b lie directly against opposite surfaces of the functional element 5. The barrier films 3b, 4b are positioned substantially congruent with one another. The functional element 5 and the barrier films 3b, 4b overlap by x=15 mm in order to obtain good sealing of the edge 8. The overhang u of the barrier films 3b, 4b beyond the circumferential edge 8 of the functional element 5 is 10 mm. Here, the barrier films 3b, 4b have an overhang u on all sides and an overlap x on all sides protruding beyond the functional element 5. Here, “on all sides” means that the overhang u and the overlap x are present on each side edge of the circumferential edge 8. In the region of the overhang u, the surfaces of the first barrier film 3b and the second barrier film 4b touch each other directly. Thus, the circumferential edge 8 of the functional element 5 is completely enclosed by the barrier films 3b, 4b. The overhang u and the overlap x further improve the sealing of the circumferential edge 8 such that, in aging tests, the composite pane 100 with a functional element 5 shows either no brightening or hardly any visually perceptible brightening in the edge region of the functional element 5. According to the invention, diffusion of the plasticizer out of the thermoplastic laminating films 3a, 4a into the functional element 5 and degradation of the functional element 5 associated therewith are avoided. The first thermoplastic laminating film 3a and the second thermoplastic laminating film 4a are tinted gray to make the appearance of the pane attractive. The additional thermoplastic laminating film 19 is colorless and is attached adjacent the outer pane (first pane 1). The additional thermoplastic laminating film 19 is used to incorporate an additional carrier film 20 having an infrared reflecting coating 21 into the layer stack. The additional carrier film 20 is a PET film with a thickness of 50 μm that is attached between the additional thermoplastic laminating film 19 and the first thermoplastic laminating film 3a. The infrared reflecting coating 21 is oriented in the direction of the first pane 1 (outer pane) and is used to reduce heating of the passenger compartment by solar radiation.

The optical properties of the functional element 5 can be controlled by applying an electrical voltage. For the sake of simplicity, the he electrical supply lines are not shown. The controllable functional element 5 is, for example, a PDLC multilayer film, comprising an active layer 11 between two surface electrodes 12, 13 and two carrier films 14, 15. The further structure of the functional element corresponds to that described in FIG. 2a-2c.

The thermoplastic laminating films 3a, 4a and the barrier films 3b, 4b correspond in their chemical composition and their layer thickness to the dimensions described in FIG. 2a-2c.

The edge region of the roof panel is concealed by a circumferential black print 10 (circumferential peripheral masking print) that is applied at least on the inner side of the outer pane. The black print is formed by printing an opaque enamel onto the interior-side surface (facing the interior of the vehicle in the installed position) of the pane 1. Optionally, a black print 10 can also be applied on the inner side of the second pane. The circumferential edge 8 of the functional element 5 lies in the region of the black print 10 such that it is not perceptible when viewing the roof panel from the outside. The distance of the functional element 5 from the circumferential edge of the roof panel is thus smaller than the width of the black print 10. The electrical connections (not shown) are also reasonably mounted in the region of the black print 10 and thus hidden.

The barrier films 3b, 4b are in direct contact with the functional element 5, in the present case, in sheet-wise contact with the surfaces of the carrier films 14, 15, and, additionally, in direct contact with the open cross-section of the functional element 5 along the circumferential edge 8. In the region of the overhang x, the barrier films 3b, 4b are in direct sheet-wise contact with each other. Also, according to the exemplary embodiment of FIGS. 5a and 5b, no adhesive or other adhesion-promoting substances at all are used; instead, the barrier films 3b, 4b are used as pre-composites 3, 4 per FIGS. 1a and 1b with the thermoplastic laminating films 3a, 4a.

The barrier films 3b, 4b according to the invention in the region of the circumferential edge of the functional element 5 are firmly pressed and fixed against one another there by the inner pressure in the finished laminated composite pane 100, as a result of which hermetic sealing occurs even without use of adhesives. This was unexpected and surprising for the person skilled in the art.

FIG. 6 depicts a plan view of another embodiment of a composite pane according to the invention 100 as a windshield with an electrically controllable sun visor. The PDLC functional element 5 is divided by horizontal isolation lines 16 into six strip-like segments. The isolation lines 16 have, for example, a width of 40 μm to 120 μm and are spaced 3.5 cm apart. They were introduced into the prefabricated multilayer film by laser. The isolation lines 16 separate, in particular, the electrodes 12, 13 into strips isolated from one another, which have, in each case, a separate electrical connection. The segments can thus be switched independently of one another. The thinner the isolation lines 16, the less conspicuous they are. Even thinner isolation lines 16 can be realized by etching.

The height of the darkened functional element 5 can be adjusted by the segmentation. Thus, depending on the position of the sun, the driver can darken the entire sun visor or even only part of it. The figure indicates that the upper half of the sun visor is darkened and the lower half is transparent.

In a particularly convenient embodiment, the functional element 5 is controlled by a capacitive switch area arranged in the region of the functional element, wherein the driver determines the degree of darkening by the location at which he touches the pane.

The windshield per FIG. 6 comprises a trapezoidal composite pane 100 with a first pane 1 as an outer pane and a second pane 2 as an inner pane that are joined to one another via two thermoplastic laminating films 3a, 4a. The first pane 1 has a thickness of 2.1 mm and is made of a green-colored soda lime glass. The second pane 2 has a thickness of 1.6 mm and is made of a clear soda lime glass. The windshield has an upper edge D facing the roof in the installed position and a lower edge M facing the engine compartment in the installed position. The cross-section of the composite pane 100 is not depicted here in detail since it substantially corresponds to the structure per FIG. 3. Optionally, one or a plurality of thermoplastic laminating films can be inserted outside the region in which the functional element 5 is inserted into the composite pane 100.

The sun visor is formed by a commercially available PDLC multilayer film as the functional element 5 that is embedded in the thermoplastic laminating films. The height of the sun visor is, for example, 21 cm. The first thermoplastic laminating film 3a is bonded to the first pane 1; the second thermoplastic laminating film 4a is bonded to the second pane 2. A thermoplastic frame film 9 situated between the first thermoplastic laminating film 3a and the first pane 1 has a cutout, into which the cut-to-size PDLC multilayer film is inserted precisely, i.e., flush on all sides. The thermoplastic frame film 9 thus forms, so to speak, a sort of passe-partout for the functional element 5, which is thus encapsulated all around in a thermoplastic material and is protected thereby. In the region of the circumferential edge 8 of the functional element 5, a first barrier film 3b and a second barrier film 4b, which surround the edge 8 and seal the functional element 5. The first barrier film 3b is used as a pre-composite 3 with the first thermoplastic laminating film 3a, while the second barrier film 4b is used as a pre-composite 4 with the second thermoplastic laminating film 4a.

The first thermoplastic laminating film 3a has a tinted region that is arranged between the functional element 5 and the first pane 1 (outer pane). The light transmittance of the windshield is thus additionally reduced in the region of the functional element 5, and the milky appearance of the PDLC functional element 5 in the diffuse state is mitigated. The aesthetics of the windshield are thus significantly more attractive. The first thermoplastic laminating film 3a has, in the tinted region, for example, average light transmittance of 30%, with which good results are achieved. The region can be homogeneously tinted. However, it is often visually more appealing if the tinting decreases in the direction of the lower edge of the functional element 5 such that the tinted and the non-tinted regions merge smoothly.

The lower edge of the tinted region and the lower edge of the PDLC functional element 5 can be arranged flush with one another and with the barrier films 3b, 4b situated on this edge. This is, however, not necessarily the case. It is also possible for the tinted region to protrude beyond the functional element 5 or, vice versa, for the the functional element 5 to protrude beyond the tinted region. In the latter case, it would not be the entire functional element 5 that would be bonded to the first pane 1 via the tinted region.

The controllable functional element 5 is a multilayer film, analogous to the structure depicted in FIG. 2c, consisting of an active layer 11 between two surface electrodes 12, 13 and two carrier films 14, 15. The active layer 11 contains a polymer matrix with liquid crystals dispersed therein, which align themselves as a function of the electrical voltage applied to the surface electrodes, as a result of which the optical properties can be controlled. The carrier films 14, 15 are made of PET and have a thickness of, for example, 0.125 mm. The carrier films 14, 15 are provided with a coating of ITO facing the active layer 11 and having a thickness of approx. 100 nm, forming the electrodes 12, 13. The electrodes 12, 13 can be connected to the vehicle's electrical system, via bus bars (not shown) (formed, for example, by a silver-containing screen print) and via connecting cables (not shown).

A so-called “high flow PVB”, which has stronger flow behavior compared to standard PVB films, can preferably be used for the thermoplastic laminating films 3a, 4a, 9 per FIGS. 1 to 6. The layers thus flow around the barrier films 3b, 4b and the functional element 5 more strongly, creating a more homogeneous visual impression, and the transition from the functional element 5 to the laminating films is less conspicuous. The “high flow PVB” can be used for all or even for only one or more of the thermoplastic laminating films 3a, 4a, 9.

### LIST OF REFERENCE CHARACTERS

1 first pane
2 second pane
3 pre-composite comprising first thermoplastic laminating film 3a and first barrier film 3b
3a first thermoplastic laminating film
3b first barrier film
4 pre-composite comprising second thermoplastic laminating film 4a and second barrier film 4b
4a second thermoplastic laminating film
4b second barrier film
5 functional element having electrically controllable optical properties
6 cutout (of the barrier films)
7 back cut (in the edge region of the barrier films)
8 circumferential edge of the functional element 5
9 thermoplastic frame film
10 black print
11 active layer of the functional element 5
12 first surface electrode of the functional element 5
13 second surface electrode of the functional element 5
14 first carrier film
15 second carrier film
16 isolation lines
17 cutting tool
18 cuts
19 additional thermoplastic laminating film
20 additional carrier film
21 infrared reflecting coating
100 composite pane
u overhang
x overlap
AA′, BB′ section lines
Z enlarged region
C field of vision
M engine edge
D roof edge

1. A method for producing a composite pane with a functional element having electrically controllable optical properties, the method comprising:
a) providing a first pre-composite comprising a first thermoplastic laminating film and a first barrier film as well as a second pre-composite comprising a second thermoplastic laminating film and a second barrier layer and trimming the first and second pre-composites substantially to dimensions of the composite pane to be produced,
b) forming a circumferential back cut in the first and second barrier films,
c) arranging a first pane, the first pre-composite, a functional element, the second pre-composite, and a second pane one over another in this order, wherein the first and second barrier films are arranged sheet-wise directly adjacent the functional element with, at least in sections, a common overhang that is beyond the circumferential edge of the functional element and surrounds the circumferential edge of the functional element, and
d) bonding the layer stack comprising, in this order, the first pane, the first thermoplastic laminating film, the first barrier film, the functional element, the second barrier film, the second thermoplastic laminating film, and the second pane by autoclaving to form the composite pane.

2. The method according to claim 1, wherein before step a), the first barrier film is joined to the first thermoplastic laminating film by heating to form a first pre-composite and/or the second barrier film is joined to the second thermoplastic laminating film by heating to form a second pre-composite.

3. The method according to claim 1, wherein in step b), cutouts are made in the barrier films of the pre-composites.

4. The method according to claim 1, wherein in step c), a thermoplastic frame film is arranged between the first pane and the first thermoplastic laminating film and/or between the second pane and the second thermoplastic laminating film, which thermoplastic frame film surrounds the region of the first thermoplastic laminating film and/or the second thermoplastic laminating film into which the functional element is introduced.

5. The method according to claim 1, wherein the first thermoplastic laminating film and/or the second thermoplastic laminating film contain in each case at least one plasticizer.

6. The method according to claim 5, wherein the first and the second thermoplastic laminating film contain at least 3 wt. % of a plasticizer, and the plasticizer contains or is made of aliphatic diesters of tri- or tetraethylene glycol.

7. The method according to claim 1, wherein the thermoplastic laminating films contain at least 60 wt. % of polyvinyl butyral (PVB).

8. The method according to claim 1, wherein the first and the second barrier film are implemented such that the first and the second barrier film prevent the diffusion of plasticizer through the barrier film.

9. The method according to claim 8, wherein the first and the second barrier film are plasticizer-free and contain or are made of polyethylene terephthalate (PET) or polyvinyl fluoride (PVF).

10. The method according to claim 1, wherein the material composition of the first and second barrier films differs in terms of its main constituent by weight from the main constituent by weight of the thermoplastic laminating films.

11. The method according to claim 10, wherein the first and second barrier films contain polyethylene terephthalate (PET) as the main constituent by weight and the thermoplastic laminating films contain polyvinyl butyral (PVB) as the main constituent by weight.

12. A composite pane containing a functional element having electrically controllable optical properties produced in a method according to claim 1, comprising in this order
a first pane,
a first pre-composite comprising a first thermoplastic laminating film with at least one plasticizer and a first barrier film, wherein the first barrier film is in direct contact with the circumferential edge of the functional element,
a functional element,
a second pre-composite comprising a second thermoplastic laminating film with at least one plasticizer and a second barrier layer, wherein the second barrier film is in direct contact with the circumferential edge of the functional element,
a second pane,
wherein
the first and second barrier films are arranged sheet-wise directly adjacent the functional element, surround the circumferential edge of the functional element, and touch one another sheet-wise at least in sections in an overhang protruding beyond the functional element.

13. The composite pane according to claim 12, wherein the overhang of the first and the second barrier film protruding beyond the functional element is at least 1 mm, and the overhang of the first and the second barrier film protruding beyond the functional element is at most 50 mm.

14. The composite pane according to claim 12, wherein the functional element is a polymer dispersed liquid crystal film.

15. The composite pane according to claim 12, wherein in the region of the functional element, cutouts are made in the barrier films of the pre-composite, and the first barrier film and/or the second barrier film are implemented in each case in the form of a continuous circumferential frame.

16. The method according to claim 6, wherein the first and the second thermoplastic laminating film contain at least 30 wt.-% of a plasticizer.

17. The method according to claim 6, wherein the plasticizer is triethylene glycol-bis-(2-ethyl hexanoate).

18. The method according to claim 7, wherein the thermoplastic laminating films contain at least 90 wt.-% of polyvinyl butyral (PVB).

19. The composite pane according to claim 13, wherein the overhang of the first and second barrier film protruding beyond the functional element is at least 5 mm.

20. The composite pane according to claim 13, wherein the overhang of the first and the second barrier film protruding beyond the functional element is at most 20 mm.
